(19) United States
(12) Patent Application Publication
(10) Pub. No.: US 2017/0324109 A1
(43) Pub. Date: Nov. 9, 2017

(54) FUEL CELL STACK, FUEL CELL AND SHELL

(71) Applicant: SHENZHEN OUDE NEW ENERGY TECHNOLOGY CO., LTD, Shenzhen (CN)

(72) Inventors: Runzhi MA, Shenzhen (CN); Jian SHI, Shenzhen (CN)

(73) Assignee: SHENZHEN OUDE NEW ENERGY TECHNOLOGY CO., LTD, Shenzhen (CN)

(21) Appl. No.: 15/522,782

(22) PCT Filed: Aug. 18, 2015
(86) PCT No.: PCT/CN2015/087319

§ 371 Date: Jun. 8, 2017

(30) Foreign Application Priority Data
Oct. 31, 2014 (CN) 201410608631.1

(51) Int. Cl. H01M 8/24; H01M 8/04276; H01M 8/0289

(52) U.S. Cl. CPC H01M 8/24; H01M 8/0289; H01M 8/04276

(57) ABSTRACT

A fuel cell stack, includes a plurality of fuel cells. Each fuel cell includes a shell, an anode and a cathode mounted in the shell. A liquid storage chamber used for storing electrolyte and a communicating part used for communicating the liquid storage chamber are provided in the shell of each fuel cell. The liquid storage chambers of every two adjacent fuel cells communicate by the communicating part. The liquid storage chambers of every two adjacent fuel cells communicate through the communicating part, so that the electrolyte of each fuel cell can cross flow each other to make the electrolyte of each unit highly consistent. Therefore, the performance parameters of each fuel cell in the same fuel cell stack are basically the same, rendering the working performance of fuel cell stack improved. The present invention also relates to a fuel cell and a shell.

### CROSS REFERENCE TO RELATED APPLICATIONS

This application is the national phase entry of International Application No. PCT/CN2015/087319, filed on Aug. 18, 2015, which is based upon and claims priority to Chinese Patent Application No. 201410608631.1 (CN), filed on Oct. 31, 2014, the entire contents of which are incorporated herein by reference.

### TECHNICAL FIELD

The present invention relates to a fuel cell stack, fuel cell and shell.

### BACKGROUND

The fuel cell performs oxidation-reduction reaction by oxygen or other oxidants to convert the chemical energy of the fuel into electric energy. The fuel cell mainly includes a shell, an anode and a cathode. A liquid storage chamber is provided in the shell for storing electrolyte. The anode and the cathode are mounted inside the liquid storage chamber. This type of battery can provide a stable electric power continuously until the fuel runs out.

However, a single fuel cell can only output relative low voltage. In general, a plurality of fuel cells are connected in series to form a fuel cell stack, in order to meet the power requirements of the application objects. The reaction heat will be generated during the work process of the fuel cell stack. Since the chemical reaction of each fuel cell takes place in its own sealed liquid storage chamber, so that the reaction heat of each fuel cell is unbalanced. Thus, the performance of the fuel cell stack is uneven.

Besides, when adding the electrolyte into the fuel cell stack, the electrolyte needs to be added one by one for each fuel cell, which is time-consuming and laborious. Furthermore, it is possible to miss out on adding electrolyte to any fuel cell.

### SUMMARY OF THE INVENTION

As to the deficiencies of prior art, the present invention is aimed to provide a fuel cell stack, fuel cell and shell which can solve the described technical problems.

In order to realize the above purpose, the technical solution in the present invention is provided as below:

A fuel cell stack, comprises a plurality of fuel cells.

Each fuel cell includes a shell, an anode and a cathode mounted in the shell, a liquid storage chamber used for storing electrolyte and a communicating part used for communication between the liquid storage chambers are provided in the shell of each fuel cell. Liquid storage chambers of two adjacent fuel cells communicate through the communicating part.

Preferably, an upper communicating port and a lower communicating port used for communication between the liquid storage chambers are provided on the upper end and the lower end of each shell. Upper communicating ports or lower communicating ports of two adjacent shells communicate with each other. The communicating part is the upper communicating port or the lower communicating port.

Preferably, a cross-sectional area of the communicating part is 1.1 cm² to 3.2 cm².

Preferably, the upper communicating port of the first fuel cell in the fuel cell stack is used for filling electrolyte, or a liquid inlet used for filling electrolyte is provided in the upper end of the shell of the first fuel cell.

Preferably, the upper communicating port of the last fuel cell in the fuel cell stack is used for discharging gas, or a discharged outlet used for discharging gas is provided in the upper end of the shell of the last fuel cell.

Preferably, a cathode accommodating part used for mounting the cathode is provided in each shell, an anode accommodating part used for mounting the anode is provided in the shell, and the liquid storage chamber is located between the cathode accommodating part and anode accommodating part.

Preferably, the anode includes an anode plate and an anode support. The anode support is provided on the upper end of the anode plate for fixing the anode plate inside the shell. The anode is flat shaped.

A fuel cell, comprises a shell, an anode and a cathode mounted in the shell, and a liquid storage chamber used for storing electrolyte and a communicating part used for communication between the liquid storage chambers are provided in the shell. The communicating part is used for communication between the liquid storage chambers of adjacent fuel cells.

Preferably, two upper communicating ports respectively provided on two sides of the anode are provided in the upper end of the shell. The communicating part is upper communicating port.

Alternatively, an upper communicating port and a lower communicating port are respectively provided in the upper end and the lower end of the shell. The communicating part is the upper communicating port or the lower communicating port.

A cross-sectional area of the communicating part is 1.1 cm² to 3.2 cm².

A fuel cell shell, provides a liquid storage chamber used for storing electrolyte and a communicating part used for communication between the liquid storage chambers. The communicating part is used for communication between the liquid storage chambers of adjacent fuel cells.

The beneficial effects of the present invention are provided as below:

1. The liquid storage chambers of two adjacent fuel cells in the present invention communicate through the communicating part, so that the electrolyte of each fuel cell can cross flow to reach the reaction heat balance of the electrolyte. Therefore, the performance parameters of each fuel cell in one fuel cell stack are consistent, optimizing the work performance of the fuel cell stack.

2. A cross-sectional area of the communicating part is 1.1 cm² to 3.2 cm². In this way, the by-pass current between two adjacent fuel cells can be 0.1 A to 2 A, so that the work performance of the fuel cell stack is better.

3. It is only required to fill electrolyte into the first fuel cell, then the electrolyte is also added into the liquid storage chambers of the remaining fuel cells at the same time, which saves time and efforts. Further, it can avoid missing out any fuel cell fundamentally to make the maintenance work of the battery safer and more convenient.

4. The gas generated from the chemical reaction within each fuel cell is collected together and discharged through the upper communicating port of the last fuel cell, which simplifies the structure of the fuel cell stack. It also ensures that the decompression effect and reaction effect of each fuel cell are consistent. Besides, when the fuel cell stack falls down due to the incidence, the upper communicating port of the last fuel cell can also be used for discharging the electrolyte, so that the chemical reaction will stop to avoid the damage of the fuel cell stack.

### BRIEF DESCRIPTION OF THE DRAWINGS

FIG. 1 is a structural diagram of the preferred embodiment of the fuel cell stack in the present invention.

FIG. 2 is a structural diagram of a single fuel cell shell of the preferred embodiment of the fuel cell stack in the present invention.

FIG. 3 is a structural diagram of a single fuel cell of the preferred embodiment of the fuel cell stack in the present invention.

FIG. 4 is a structural diagram of an anode of the fuel cell stack shown in FIG. 1 to FIG. 3.

### DETAILED DESCRIPTION OF THE EMBODIMENTS

The present invention will be further described, in combination with the drawings and specific embodiments:

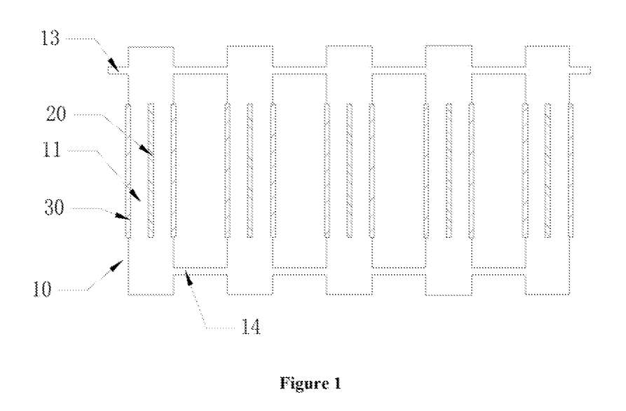

Referring to FIG. 1, the present invention relates to a fuel cell stack, wherein the preferred embodiment includes a plurality of fuel cells 10.

Each fuel cell 10 includes a shell, anode 20 and cathode 30 mounted in the shell. Liquid storage chamber 11 that is used for storing electrolyte and a communicating part used for communication between liquid storage chambers 11 are provided in the shell of each fuel cell 10. Liquid storage chambers 11 of two adjacent fuel cells 10 are communicate through the communicating part, so that the electrolyte of each fuel cell 10 can cross flow to reach the reaction heat balance of the electrolyte. Therefore, the performance parameters of each fuel cell in one fuel cell stack are the consistent, optimizing the work performance of the fuel cell stack.

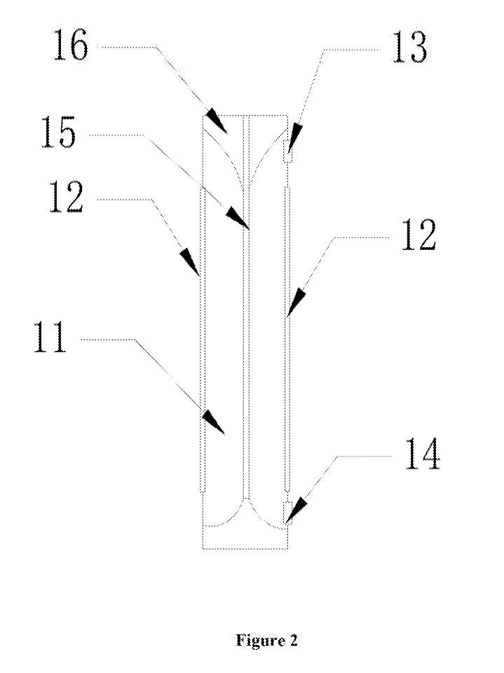

Referring to FIG. 2, in this embodiment, cathode accommodating part 12 used fur mounting cathode 30 is provided in each shell, anode accommodating part 15 used for mounting anode 20 is provided in the shell, and liquid storage chamber 11 is located between anode accommodating part 15 and cathode accommodating part 12. In this way, the effect of the chemical reaction will be better. Upper communicating port 13 and lower communicating port 14 which are used for communication between liquid storage chambers 11 are respectively provided on the upper end and the lower end of the shell. Upper communicating ports 13 or lower communicating ports 14 of every two adjacent shells communicate with each other. The communicating part is upper communicating port 13 or lower communicating port 14.

In this way, the electrolyte can flow from liquid storage chamber 11 of first fuel cell 10 into liquid storage chamber 11 of second fuel cell 10, through lower communicating port 14 or upper communicating port 13 of first fuel cell 10 and lower communicating port 14 or upper communicating port 13 of second fuel cell 10. Then the electrolyte flows through lower communicating port 14 or upper communicating port 13 of second fuel cell 10 into liquid storage chamber 11 of third fuel cell 10, through lower communicating port 14 or upper communicating port 13 of third fuel cell 10, rendering the reaction heat balance effect of the electrolyte of each fuel cell 10 better.

Anode limiting slot 16 is also provided in the shell, used for limiting the position of the anode.

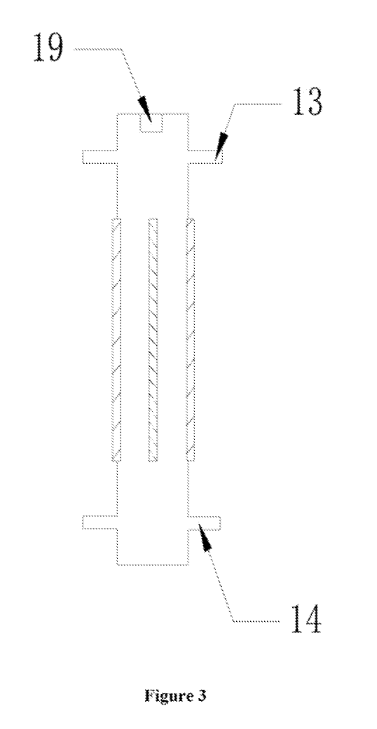

Referring to FIG. 3, in this embodiment, upper communicating port 13 and lower communicating port 14 can be located on two sides of anode 20, or can be located on the same side of anode 20.

Upper communicating port 13 and lower communicating port 14 of each two adjacent shells can directly communicate or communicate through a delivery pipe.

The number of upper communicating port 13 and lower communicating port 14 can be one or more.

Preferably, a cross-sectional area of the communicating part is 1.1 cm² to 3.2 cm². In this way, the value of the by-pass current between two adjacent fuel cells 10 can be 0.1 A to 2 A, so that the work performance of the fuel cell stack is better.

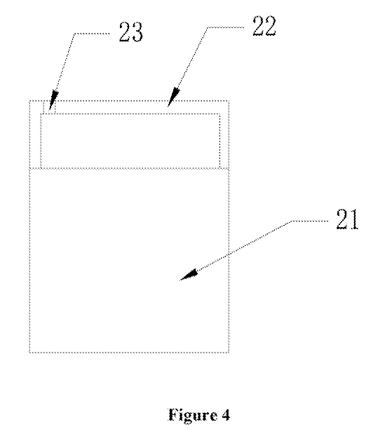

Referring to FIG. 1, in the embodiment, upper communicating port 13 of the first fuel cell 10 in the fuel cell stack is used as a liquid inlet for filling electrolyte. Referring to FIG. 4, in other embodiments, liquid inlet 19 used for filling electrolyte is provided on the upper end of the shell of the first fuel cell 10. Thus, it only required to fill electrolyte into the first fuel cell 10, then the electrolyte is also added into liquid storage chambers 11 of the remaining fuel cells 10 at the same time, which saves time and efforts. Further, it can avoid missing out any fuel cell fundamentally to make the maintenance work of the battery safer and more convenient.

In this embodiment, upper communicating port 13 of the last fuel cell 10 in the fuel cell stack is used for discharging gas. The gas generated from the chemical reaction of each fuel cell 10 is collected together and discharged through upper communicating port 13 of the last fuel cell 10, which simplifies the structure of the fuel cell stack. It can also ensure that the decompression effect and reaction effect of each fuel cell 10 are consistent. Besides, when the fuel cell stack fails due to the incidence, upper communicating port 13 of the last fuel cell 10 can be used for discharging the electrolyte, so that the chemical reaction will stop to avoid the damage of the fuel cell stack. In other embodiments, a discharged outlet used for discharging gas is provided on an upper end of the last fuel cell 10.

In other embodiments, two upper communicating ports respectively on two sides of the anode are provided on the upper end of each shell. The liquid storage chambers of each two adjacent shells communicate through the upper communicating ports, and then the flowing direction of the electrolyte in each fuel cell is that the electrolyte flows into each fuel cell from top to bottom while the electrolyte flows out of each fuel cell from bottom to top.

Referring to FIG. 4, in this embodiment, anode 20 includes anode plate 21 and anode support 22. Anode support 22 is provided on the upper end of anode plate 21 for fixing anode plate 21 inside the shell. Anode plate 21 is flat shaped, which can ensure that the reaction area of anode plate 21 will not be reduced in the chemical reaction, so that the even and stable electric current is provided. Besides, it facilitates increasing the contact area with the electrolyte to raise reaction efficiency.

Preferably, liquid through hole 23 is provided in anode support 22, and liquid through hole 23 communicates to liquid inlet 19 of the shell.

Preferably, anode 20 is aluminium-magnesium alloy, and the cathode is air electrode. The electrolyte is neutral electrolyte solution.

For the ordinary skilled person in the art, various modifications and transformations based on the described technical solution and concept are within the scope of the claimed present invention.

What is claimed is:

1. A fuel cell stack, comprising: a plurality of fuel cells; each fuel cell includes a shell, an anode and a cathode mounted in the shell, a liquid storage chamber used for storing electrolyte and a communicating part used for communication between liquid storage chambers are provided in the shell of the each fuel cell; liquid storage chambers of each two adjacent fuel cells communicate through the communicating part.

2. The fuel cell stack of claim 1, wherein an upper communicating port and a lower communicating port used for communication between the liquid storage chambers are provided respectively in an upper end and a lower end of each shell; the upper communicating ports or the lower communicating ports of the each two adjacent shells communicate to each other; the communicating part is the upper communicating port or the lower communicating port.

3. The fuel cell stack of claim 1, wherein a cross-sectional area of the communicating part is 1.1 cm² to 3.2 cm².

4. The fuel cell stack of claim 2, wherein an upper communicating port of a first fuel cell in the find cell stack is used for filling electrolyte, or a liquid inlet used for filling electrolyte is provided in an upper end of the shell of the first fuel cell.

5. The fuel cell stack of claim 2, wherein an upper communicating port of a last fuel cell in the fuel cell stack is used for discharging gas, or a discharged outlet used for discharging gas is provided in an upper end of the shell of the last fuel cell.

6. The fuel cell stack of claim 1, wherein a cathode accommodating part used for mounting the cathode is provided in each shell, an anode accommodating part used for mounting the anode is provided in the each shell, and the liquid storage chamber is located between the cathode accommodating part and the anode accommodating part.

7. The fuel cell stack of claim 1, wherein the anode includes an anode plate and an anode support; the anode support is provided on the upper end of the anode plate for fixing the anode plate inside the shell; the anode is flat shaped.

8. A fuel cell, comprising: a shell, an anode and a cathode mounted in the shell, a liquid storage chamber used for storing electrolyte and a communicating part used for communication between liquid storage chambers are provided in the shell; the communicating part is used for communication between the liquid storage chambers of adjacent fuel cells.

9. The fuel cell of claim 8, wherein two upper communicating ports respectively provided on two sides of the anode are provided in an upper end of the shell; the communicating part includes two upper communicating ports; an cross-sectional area of the communicating part is 1.1 cm² to 3.2 cm².

10. A fuel cell shell, comprising: a liquid storage chamber used for storage electrolyte and a communicating pan used for communication between liquid storage chambers in the shell; the communicating part is used fin communication between the liquid storage chambers of adjacent fuel cells.

11. The fuel cell stack of claim 3, wherein the upper communicating port of a first fuel cell in the fuel cell stack is used for filling electrolyte, or a liquid inlet used for tilling electrolyte is provided in an upper end of the shell of the first fuel cell.

12. The fuel cell stack of claim 3, wherein an upper communicating port of a last fuel cell in the fuel cell stack is used for discharging gas, or a discharged outlet used for discharging gas is provided in an upper end of the shell of the last fuel cell.

13. The fuel cell of claim 8, wherein an upper communicating port and a lower communicating port are provided in an upper end and a lower end of the shell; the communicating part is the upper communicating port or the lower communicating port; a cross-sectional area of the communicating part is 1.1 cm² to 3.2 cm².
